(19) United States
(12) Patent Application Publication
(10) Pub. No.: US 2008/0166276 A1
(43) Pub. Date: Jul. 10, 2008

(54) Catalytic Reactor

(75) Inventor: Michael Joseph Bowe, Lancashire (GB)

Correspondence Address: LAW OFFICES OF WILLIAM H. HOLT, 12311 HARBOR DRIVE, WOODBRIDGE, VA, 22192, US

(73) Assignee: CompactGTL plc, Abingdon, Oxfordshire (GB)

(21) Appl. No.: 11/816,545

(22) PCT Filed: Jan. 18, 2006
(86) PCT No.: PCT/GB2006/050012

§ 371 Date: Aug. 17, 2007

(30) Foreign Application Priority Data
Feb. 25, 2005 (GB) 0503908.6

(51) Int. Cl. B01J 19/00

(52) U.S. Cl. 422/196

(57) ABSTRACT

A compact catalytic reactor (10) for performing a chemical reaction between reactants defines a multiplicity of first and second flow channels (16, 17) arranged alternately, the first flow channels providing flow paths for reactants and the second flow channels providing a source of heat for the reaction. Each flow channel in which a chemical reaction is to take place contains a removable fluid-permeable catalyst structure (20). The walls defining the first flow channels (16), and preferably those of the second flow channels (17) too, are treated so as to have surfaces with a high emissivity. This reactor is particularly suited to reactions carried out at a temperature above about 500° C., at which temperature radiative heat transfer becomes significant.

This invention relates to a catalytic reactor, suitable for use in a chemical process which is carried out at an elevated temperature, and which requires heat transfer. For example the process might be a reforming process.

A process is described in WO 01/51194 and WO 03/048034 (Accentus plc) in which methane is reacted with steam, to generate carbon monoxide and hydrogen in a first catalytic reactor; the resulting gas mixture is then used to perform Fischer-Tropsch synthesis in a second catalytic reactor. The overall result is to convert methane to hydrocarbons of higher molecular weight, which are usually liquid or waxy under ambient conditions. The two stages of the process, steam/methane reforming and Fischer-Tropsch synthesis, require different catalysts, and heat to be transferred to or from the reacting gases, respectively, as the reactions are respectively endothermic and exothermic. The reforming reaction is typically carried out at a temperature of about 800° C., and the heat required may be provided by catalytic combustion.

According to the present invention there is provided a compact catalytic reactor for performing a chemical reaction between reactants, the reactor defining a multiplicity of first and second flow channels arranged alternately, the first flow channels providing flow paths for reactants and the second flow channels providing a source of heat for the reaction, wherein each flow channel in which a chemical reaction is to take place contains a removable fluid-permeable catalyst structure; wherein the walls defining the first flow channels have surfaces with a high emissivity.

Preferably the walls are treated to ensure the emissivity is at least twice the value for a polished shiny surface, or is at least 0.6, more preferably at least 0.7. For example the surfaces may be treated by etching or by anodising. Hence the emissivity may be raised to 0.90 or 0.95, although this depends on the material. Preferably the walls defining the second flow channels also have such a high emissivity. The values of emissivity are the values of total emissivity at the temperature of operation of the reactor. Such increased emissivity implies increased absorption and emission of radiation.

The reactor is particularly suitable for reactions carried out at a temperature above about 500° C., particularly for reactions above say 750° C., and the material defining the flow channels is exposed to the hot reactive gases, so that the material for making the reactor must be strong and resistant to corrosion at this temperature. For example, in the case of a reactor for steam reforming, suitable metals are iron/nickel/chromium alloys for high-temperature use, such as Haynes HR-120 or Inconel 800HT (trade marks), or similar materials.

The reactor may comprise a stack of plates. For example, the first and second flow channels may be defined by grooves in respective plates, the plates being stacked and then bonded together. Alternatively the flow channels may be defined by thin metal sheets that are castellated and stacked alternately with flat sheets; the edges of the flow channels may be defined by sealing strips. To ensure the required good thermal contact both the first and the second gas flow channels may be between 10 mm and 2 mm deep, preferably less than 6 mm deep, more preferably in the range 3 mm to 5 mm. The stack of plates forming the reactor module is bonded together for example by diffusion bonding, brazing, or hot isostatic pressing. But it will be appreciated that the surfaces of the plates need to be free from surface imperfections where bonding is to occur, and so will usually be given a high surface finish prior to assembly and bonding, this giving them a low emissivity; the treatment to raise the emissivity is therefore usually carried out after assembly of the reactor components, although it may be carried out beforehand.

The catalyst structure preferably has a metal substrate to provide strength and to enhance thermal transfer by conduction, so preventing hotspots. Typically the metal substrate would be covered with a ceramic coating into which active catalytic material is incorporated. Preferably the metal substrate for the catalyst structure is a steel alloy that forms an adherent surface coating of aluminium oxide when heated, for example an aluminium-bearing ferritic steel (eg Fecralloy (TM)). When this metal is heated in air it forms an adherent oxide coating of alumina, which protects the alloy against further oxidation and against corrosion. Where the ceramic coating is of alumina, this appears to bond to the oxide coating on the surface. Preferably each catalyst structure is shaped so as to subdivide the flow channel into a multiplicity of parallel flow sub-channels, with catalytic material on surfaces within each such sub-channel. The substrate may be a foil, a wire mesh or a felt sheet, which may be corrugated, dimpled or pleated; the preferred substrate is a thin metal foil for example of thickness less than 100 μm.

Thus in one embodiment the catalyst structure incorporates a corrugated metal foil. The catalyst structure is not structural, that is to say it does not provide strength to the reactor, so that such a catalyst structure may be inserted into each flow channel, with a catalyst suited to the corresponding reaction. The catalyst structures are removable from the channels in the reactor, so they can be replaced if the catalyst becomes spent.

Reactors suitable for the steam/methane reforming reaction may be constructed in accordance with the invention. Consequently a plant for processing natural gas to obtain longer chain hydrocarbons may incorporate a steam/methane reforming reactor of the invention, to react methane with steam to form synthesis gas.

The invention will now be further and more particularly described, by way of example only, and with reference to the accompanying drawings, in which:

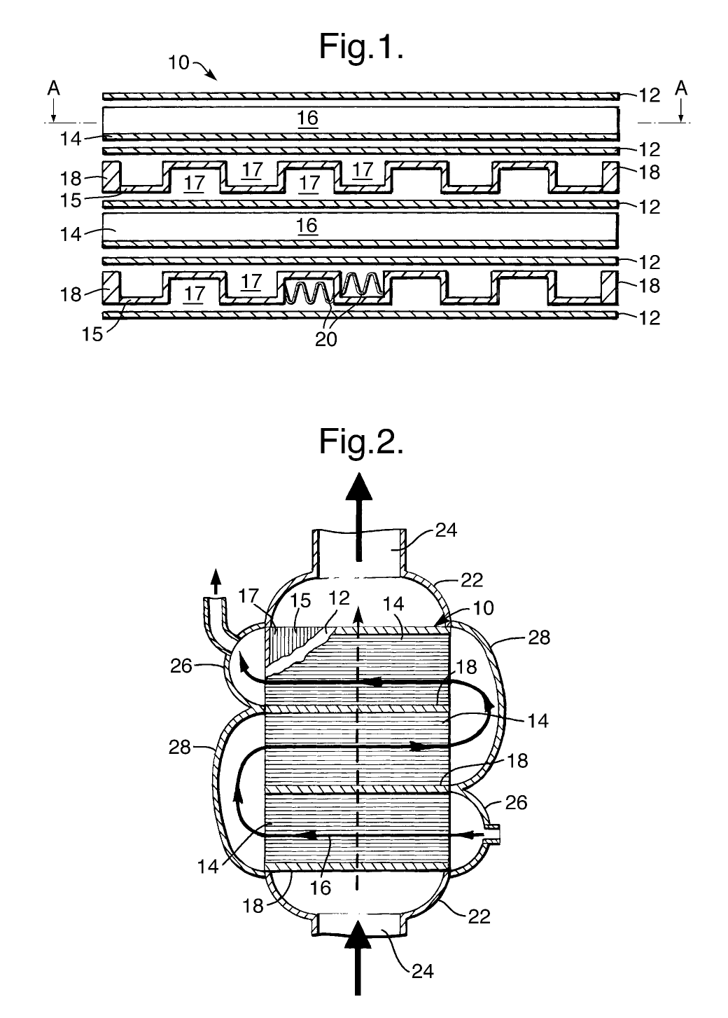

FIG. 1 shows a sectional view of part of a reactor block suitable for steam/methane reforming, with the parts shown spaced apart; and

FIG. 2 shows a sectional view, partly broken away, on the line A-A of FIG. 1 but after assembly of the reactor block.

The steam reforming reaction is brought about by mixing steam and methane, and contacting the mixture with a suitable catalyst at an elevated temperature so the steam and methane react to form carbon monoxide and hydrogen. The temperature in the reformer reactor typically increases from about 450° C. at the inlet to about 800-850° C. at the outlet. The steam reforming reaction is endothermic, and the heat may be provided by catalytic combustion, for example of hydrocarbons and hydrogen mixed with air. The combustion takes place over a combustion catalyst within adjacent flow channels within the reforming reactor.

Referring now to FIG. 1 there is shown a reactor block 10 suitable for use as a steam reforming reactor, with the components separated for clarity. The reactor block 10 consists of a stack of plates that are rectangular in plan view, each plate being of corrosion resistant high-temperature steel such as Inconel 800HT or Haynes HR-120. Flat plates 12 of thickness 1 mm are arranged alternately with castellated plates 14, 15 in which the castellations are such as to define straight-through channels 16, 17 from one side of the plate to the other. The castellated plates 14 and 15 are arranged in the stack alternately, so the channels 16, 17 are oriented in orthogonal directions in alternate castellated plates 14, 15. The thickness of the castellated plates 14 and 15 (typically in the range between 0.2 and 3.5 mm) is in each case 0.75 mm. The height of the castellations (typically in the range 2-10 mm) is 4 mm in this example, and solid edge strips 18 of the same thickness are provided along the sides. In the castellated plates 15 which define the combustion channels 17 the wavelength of the castellations is such that successive ligaments are 25 mm apart, while in the castellated plates 14 which define the reforming channels 16 successive ligaments are 15 mm apart.

Referring now to FIG. 2, which shows a sectional view through the reactor block 10, each plate 12 is rectangular, of width 600 mm and of length 1200 mm; the section is in a plane parallel to one such plate 12. The castellated plates 15 for the combustion channels 17 are of the same area in plan, the castellations running lengthwise. The castellated plates 14 for the reforming channels 16 are 600 mm by 400 mm, three such plates 14 being laid side-by-side, with edge strips 18 between them, with the channels 16 running transversely. Headers 22 at each end of the stack enable the combustion gases to be supplied to, and the exhaust gases removed from, the combustion channels 17 through pipes 24. Small headers 26 (bottom right and top left as shown) enable the gas mixture for the reforming reaction to be supplied to the channels 16 in the first of the castellated plates 14, and the resulting mixture to be removed from those in the third castellated plate 14; double-width headers 28 (top right and bottom left as shown) enable the gas mixture to flow from one castellated plate 24 to the next. The overall result is that the gases undergoing reforming follow a zigzag path that is generally co-current relative to the flow through the combustion channels 17.

The stack is assembled as described above, and bonded together. Corrugated metal foil catalyst carriers 20 (only two of which are shown, in FIG. 1) are then inserted into each of the channels, carrying catalysts for the two different reactions. The metal foil is preferably of an aluminium-containing steel alloy such as Fecralloy. The headers 22, 26 and 28 can then be attached to the outside of the stack, as shown in FIG. 2.

The bonding procedure is typically diffusion bonding, brazing, or hot isostatic pressing, and these processes need the plates to have smooth surfaces—either for the braze to flow without voids, or for grain growth to occur between adjacent surfaces. The plates are therefore typically rolled to a high surface finish, prior to forming of any castellations, and assembly of the plates. The resulting surfaces are reflective and consequently of comparatively low emissivity (typically about 0.3 if they are of Inconel). Because of the high temperatures of the surfaces during operation of the reactor, radiative heat transfer plays a significant role in transferring heat in the reactor, although heat is also transferred by forced convection as the gases flow through the channels, and by conduction through the plates. The surfaces of the catalyst carriers 20 are typically of high emissivity (say about 0.8), because of the ceramic coating and the particles of catalytically active materials. The overall heat transfer involves radiation from the catalyst carrier 20 in the combustion channel 17 to the walls of the combustion channel 17; a proportion of the radiation is absorbed into the metal, and conducted as heat through the thickness of the plates to the wall of the reformer channels 16; here some is emitted as radiation, to be absorbed by the surface of the reforming catalyst carrier 20. It will therefore be appreciated that a significant resistance to radiative heat transfer is at the surfaces of both the sets of flow channels 16 and 17.

Accordingly, after assembly and bonding of the reactor block 10, but prior to insertion of the catalyst carriers 20, the channels 16 and 17 are subjected to a processing step to roughen their surfaces and to increase the emissivity of these surfaces. For example this may be chemical etching, carried out by immersing the reactor block in a bath of a suitably corrosive chemical such as an acid, followed by draining, rinsing and drying. This etchant may be one that attacks grain boundaries. Its composition will depend on the material of which the reactor is made, but by way of example might comprise hydrochloric acid with hydrogen peroxide, or acidic ferric chloride, or possibly nitric acid combined with hydrogen fluoride.

The process to increase the emissivity of the surfaces may be different from that described here. The reactor block 10 might instead be subjected to a high temperature stand in an atmosphere containing oxygen, so as to form metal oxide on the surfaces. Another alternative would be to anodise the surfaces. And another alternative would be to provide a thin coating of high emissivity material on the walls, for example by a slurry deposition process. And another alternative would be to pass a slurry of abrasive particles through the channels.

It will be appreciated that the reactor design shown in the figures is by way of example only, and that the invention is applicable in any compact catalytic reactor for use at an elevated temperature, above say 450° C. For example it is equally applicable in a reactor in which flow channels are defined by grooves in flat plates, or indeed where flow channels are defined by apertures in plates.

1. A compact catalytic reactor for performing a chemical reaction between reactants at a temperature above 500° C., said reactor defining a multiplicity of first and second flow channels arranged alternately, said first flow channels providing flow paths for reactants and said second flow channels providing a source of heat for said reaction, wherein each flow channel in which a chemical reaction is to take place contains a removable fluid-permeable catalyst structure; wherein the walls defining said first flow channels are of metal, and have roughened uncoated surfaces to provide a high emissivity at the temperature of operation of said reactor.

2. A reactor as claimed in claim 1 wherein said walls are treated to ensure said emissivity is at least twice the value for a polished shiny surface, or is at least 0.6.

3. A reactor as claimed in claim 1 wherein said emissivity is at least 0.7.

4. A reactor as claimed in claim 1 wherein the walls defining said second flow channels also have such a high emissivity.

5. A reactor as claimed in claim 1 wherein the means defining said first and second flow channels are of an iron/nickel/chromium alloy.

6. A reactor as claimed in claim 1 wherein said catalyst structure comprises a metal substrate with a ceramic coating into which active catalytic material is incorporated, and is shaped so as to subdivide said flow channel into a multiplicity of parallel flow sub-channels, with catalytic material on surfaces within each such sub-channel.

7. (canceled)

8. A plant for performing a steam methane reforming reaction incorporating a reactor as claimed in claim 1.

9. A plant for processing natural gas to obtain longer chain hydrocarbons comprising a steam/methane reforming reactor as claimed in claim 8, to react methane with steam to form synthesis gas.

10. A reactor as claimed in claim 2 wherein said emissivity is at least 0.7.

11. A reactor as claimed in claim 2 wherein said walls defining the second flow channels also have such a high emissivity.

12. A reactor as claimed in claim 3 wherein said walls defining said second flow channels also have such a high emissivity.

13. A reactor as claimed in claim 2 wherein said means defining said first and second flow channels are of an iron/nickel/chromium alloy.

14. A reactor as claimed in claim 3 wherein said means defining said first and second flow channels are of an iron/nickel/chromium alloy.

15. A reactor as claimed in claim 4 wherein said means defining said first and second flow channels are of an iron/nickel/chromium alloy.

16. A reactor as claimed in claim 2 wherein said catalyst structure comprises a metal substrate with a ceramic coating into which active catalytic material is incorporated, and is shaped so as to subdivide said flow channel into a multiplicity of parallel flow sub-channels, with catalytic material on surfaces within each such sub-channel.

17. A reactor as claimed in claim 3 wherein said catalyst structure comprises a metal substrate with a ceramic coating into which active catalytic material is incorporated, and is shaped so as to subdivide said flow channel into a multiplicity of parallel flow sub-channels, with catalytic material on surfaces within each such sub-channel.

18. A reactor as claimed in claim 4 wherein said catalyst structure comprises a metal substrate with a ceramic coating into which active catalytic material is incorporated, and is shaped so as to subdivide said flow channel into a multiplicity of parallel flow sub-channels, with catalytic material on surfaces within each such sub-channel.

19. A reactor as claimed in claim 5 wherein said catalyst structure comprises a metal substrate with a ceramic coating into which active catalytic material is incorporated, and is shaped so as to subdivide said flow channel into a multiplicity of parallel flow sub-channels, with catalytic material on surfaces within each such sub-channel.
